(19) United States
(12) Patent Application Publication
(10) Pub. No.: US 2022/0154867 A1
(43) Pub. Date: May 19, 2022

(54) SEALING ELEMENT FOR PIPES

(71) Applicant: Antonio BRAO AMO, Sabadell (ES)

(72) Inventor: Antonio BRAO AMO, Sabadell (ES)

(21) Appl. No.: 17/464,799

(22) Filed: Sep. 2, 2021

(30) Foreign Application Priority Data
Nov. 17, 2020 (ES) U202032470

(51) Int. Cl. F16L 55/11

(52) U.S. Cl. CPC F16L 55/1141

(57) ABSTRACT

The invention relates to a sealing element for pipes, comprising a body of injection-mouldable plastic material, being made up of a central stem section that has at one end a circular head region acting as a grip area, including on a stem section in a downward direction from said head region, a first centring region with a general inverted frustoconical shape, a second circumferential outer contour region that is defined by at least two flexible flaps formed from a pair of diametrically opposed grooves and a third circumferential outer contour positioning region, the second region having a larger diameter than the first and third regions. Said sealing element includes at least two spaced extensions, which protrude in one same direction perpendicular to the central stem section, which have a length equal to or less than the diameter of the third positioning region.

### RELATED APPLICATION

This application claims the benefit of priority of Spain Patent Application No. U202032470 filed on Nov. 17, 2020, the contents of which are incorporated herein by reference in their entirety.

### FIELD AND BACKGROUND OF THE INVENTION

The object of the present application is to provide a sealing element for pipes.

More specifically, the invention proposes the development of a sealing element for pipes of simple manufacture and placement that has regions which facilitate the ejection of the part during the manufacture thereof inside a mould.

Once tubular elements intended, for example, to create conduits to allow fluids to pass have been manufactured, they are usually accumulated or stored in open outdoor spaces and/or in closed areas. Since the two opposite ends of such conduits are exposed to the outside environment, the inside thereof is subject to possible dirt agents as well as the fact that small animals, such as insects, rodents, etc., can get inside.

To solve this problem, document ES 1236244 which defines a closing cap that satisfactorily solves the aforementioned drawback is known. However, it has been found that, due to the geometric configuration of the cap, it can present problems during the manufacturing process thereof, mainly arising during the step of removing the parts from the injection mould, since sometimes the parts are not automatically released from the manufacturing mould as would be desirable. This is essentially due to the distance provided between the wall of the stem and the outer flanges that have a larger diameter, which on such occasions requires the help of an operator to ensure the complete removal of all parts from the mould.

Another drawback detected is one related to the general rigidity of the cap, since it has been found that during the placement of the cap at the end of a tube, depending on how it is placed by the operator, it can deform in the area of the stem, being further placed, such that it is also desirable to obtain a higher degree of rigidity that reduces stresses.

Furthermore, the applicant is currently unaware of an invention that has all the features described in this specification.

### SUMMARY OF THE INVENTION

The present invention has been developed with the purpose of providing a sealing element which is configured as a novelty within the field of application and solves the aforementioned drawbacks, further contributing other additional advantages that will be obvious from the description below.

An object of the present invention is therefore to provide a sealing element for pipes, being of the type that comprises a body of injection-mouldable plastic material, being made up of a central stem section that has at one end a circular head region acting as a grip area, including on a stem section in a downward direction from said head region, a first centring region with a general inverted frustoconical shape, a second circumferential outer contour region that is defined by at least two flexible flaps formed from a pair of diametrically opposed grooves and a third circumferential outer contour positioning region, the second region having a larger diameter than the first and third regions. Particularly, the invention is characterised by including at least two spaced extensions, which protrude in the same direction perpendicular to the central stem section, which have a length equal to or less than the diameter of the third positioning region. These two extensions act as contact points linked to ejectors present in the mould for the manufacture of the tubular elements, in such a way that they facilitate removal and do not require the help of operators for the execution thereof, since they ensure the release of the part from the mould in each injection process of the parts at all times.

Preferably, each of the extensions is located in a region close to the two opposite ends of the central stem section. The fact that the two extensions are arranged in opposite areas with respect to the stem section facilitates the perpendicular ejection of the part from the cavity of the mould where it has been formed, preventing it from being caught in the cavity in an undesired way.

According to another aspect of the invention, the central stem has a cross-shaped cross-section. Advantageously, the cross-shaped cross-section comprised between the first and second regions has a decreasing configuration in a downstream direction from the first region towards the second region. In this way, the rigidity of the sealing element assembly is improved, while also allowing the flexibility of the flexible flaps.

Thus, the sealing element described represents an innovative structure with structural and constituent features heretofore unknown for its intended purpose, reasons which, taken together with its usefulness, provide it with sufficient grounds for obtaining the requested exclusivity privilege.

Other features and advantages of the sealing element object of the present invention will be evident in light of the description of a preferred, but not exclusive, embodiment which is illustrated by way of a non-limiting example in the drawings which are attached, wherein:

### BRIEF DESCRIPTION OF THE SEVERAL VIEWS OF THE DRAWINGS

FIG. 1 is a perspective view of a preferred embodiment of a sealing element for pipes according to the present invention;

FIG. 2 is a side elevation and plan view from below of the sealing element represented in FIG. 1;

FIG. 3 is a longitudinal cross-sectional view of the sealing element shown in the previous figures.

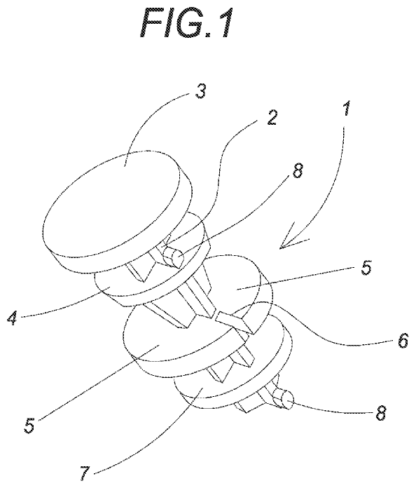

### DESCRIPTION OF SPECIFIC EMBODIMENTS OF THE INVENTION

In light of the aforementioned figures, and in accordance with the adopted numbering, one may observe therein a preferred exemplary embodiment of the invention, which comprises the parts and elements indicated and described in detail below.

The embodiment shown of the sealing element for pipes comprises a body (1) of injection-mouldable plastic material, for example, low density polyethylene (LDPE), with a degree of elasticity such that it makes it easier for the operator to assemble the cap since less effort is required to place it in the holes of a tube. Although this task is simple, it is important to bear in mind that this aspect is relevant when the operator must place a large number of sealing elements during a workday.

The body (1) is made up of an elongated central stem section (2), with a cross-shaped cross-section, which has at one end a circular head region (3) with a flat surface acting as a grip area for the user in the operations of placing and removing the sealing element at one end of the conduit, as well as abutment with the side wall of the tube, once it is assembled.

As can be seen, the head (3) notably protrudes radially with respect to the central stem section (2).

The central stem section (2) includes along the same and in a downstream direction from said head region (3) and separately, a first contour centring region (4) with a general inverted frustoconical shape provided to facilitate the fitting and therefore centring of the sealing element inside the conduit to be covered, a second circumferential outer contour region that is defined by two flexible flaps (5), which are formed from a pair of diametrically opposed grooves (6), and a third circumferential outer contour positioning region (7), the second region having a larger diameter than the first and third regions.

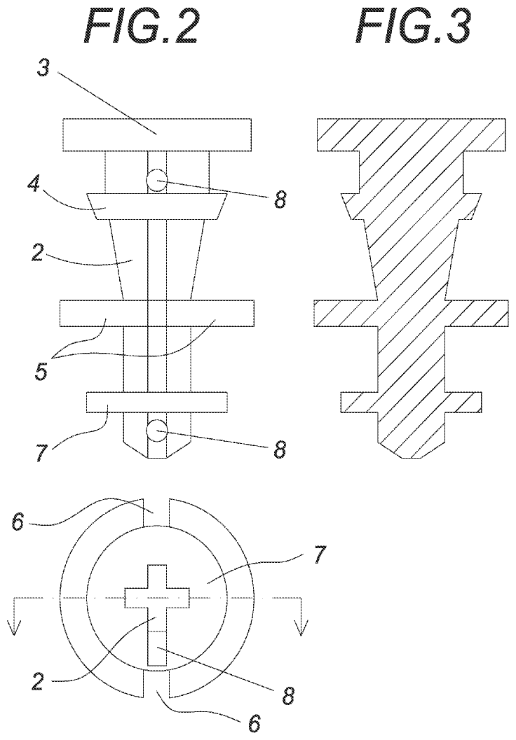

The cross-shaped cross-section comprised between the first and second regions has a decreasing configuration in a downstream direction from the first region towards the second region, as can be seen more clearly in FIGS. 2 and 3.

Additionally, it includes at least two spaced extensions (8), which protrude in one same direction perpendicular to the central stem section (2), which have a length equal to or less than the diameter of the third positioning region (7). It should also be mentioned that these extensions (8) are parallel to the grooves (6), such that it also allows them to be used as reference or guide points during the insertion action of the sealing element in a corresponding hole.

In an exemplary embodiment that is non-limiting from a dimensional point of view, the head region can have an outer diameter about 10 mm, the first centring region about 7.4 mm, the outer diameter of the flexible flaps about 10.2 mm, while the third positioning region can have a diameter about 7.4 mm.

The details, shapes, dimensions and other secondary elements, used to manufacture the sealing element of the invention, may be suitably replaced with others that do not depart from the scope defined by the claims included below.

What is claimed is:

1. A sealing element for pipes, comprising a body of injection-mouldable plastic material, being made up of a central stem section that has at one end a circular head region acting as a grip area, including on a stem section in a downward direction from said head region, a first centring region with a general inverted frustoconical shape, a second circumferential outer contour region that is defined by at least two flexible flaps formed from a pair of diametrically opposed grooves and a third circumferential outer contour positioning region, the second region having a larger diameter than the first and third regions, characterised in that it includes at least two spaced extensions, which protrude in one same direction perpendicular to the central stem section, which have a length equal to or less than the diameter of the third positioning region.

2. The sealing element for pipes according to claim 1, characterised in that each of the extensions is located in a region close to the two opposite ends of the central stem section.

3. The sealing element for pipes according to claim 1, characterised in that the central stem has a cross-shaped cross-section.

4. The sealing element for pipes according to claim 1, characterised in that the cross-shaped cross-section comprised between the first and second regions has a decreasing configuration in a downstream direction from the first region towards the second region.

5. The sealing element for pipes according to claim 2, characterised in that the central stem has a cross-shaped cross-section.

6. The sealing element for pipes according to claim 3, characterised in that the cross-shaped cross-section comprised between the first and second regions has a decreasing configuration in a downstream direction from the first region towards the second region.
